(19) United States
(12) Patent Application Publication
(10) Pub. No.: US 2018/0179932 A1
(43) Pub. Date: Jun. 28, 2018

(54) VEHICLE AND CONTROL METHOD FOR VEHICLE

(71) Applicant: TOYOTA JIDOSHA KABUSHIKI KAISHA, Toyota-shi (JP)

(72) Inventors: Ryohei ONO, Susono-shi (JP); Edgar Yoshio MORALES TERAOKA, Susono-shi (JP); Katsuhiro ITO, Mishima-shi (JP); Akira MIKAMI, Mishima-shi (JP); Keishi TAKADA, Ashigarakami-gun (JP); Masaaki SATO, Susono-shi (JP)

(73) Assignee: TOYOTA JIDOSHA KABUSHIKI KAISHA, Toyota-shi (JP)

(21) Appl. No.: 15/840,137

(22) Filed: Dec. 13, 2017

(30) Foreign Application Priority Data
Dec. 26, 2016 (JP) 2016-251234

(51) Int. Cl. F01N 3/027; F02D 41/14

(52) U.S. Cl. CPC F01N 3/027; F01N 3/32; F02D 41/1439

(57) ABSTRACT

When it is determined that there is a possibility of start-up of an internal combustion engine while regeneration control is in execution during stop of the internal combustion engine, processing of the regeneration control is stopped. Accordingly, as compared with the case where the regeneration control is continuously executed when the internal combustion engine is started up, temperature increase in a filter can be suppressed: Therefore, even when an increased amount of oxygen is supplied to the filter, an oxidation reaction is suppressed, so that overheating of the filter can be suppressed.

### INCORPORATION BY REFERENCE

The disclosure of Japanese Patent Application No. 2016-251234 filed on Dec. 26, 2016 including the specification, drawings and abstract is incorporated herein by reference in its entirety.

### BACKGROUND

### 1. Technical Field

The present disclosure relates to a vehicle having a filter that collects particulate matter contained in exhaust gas discharged from an internal combustion engine, and a control method for the vehicle.

### 2. Description of Related Art

For a vehicle having a filter disposed in an exhaust passage for collecting particulate matter (PM), a technique (PM regeneration) has conventionally been known (see, for example, US 2004/0226287 A). The technique is configured to automatically heat the filter to cause an oxidation reaction, regardless of the presence of user operation, to remove the PM accumulated on the filter when the amount of the PM accumulated on the filter is equal to or above a specified amount and when an internal combustion engine is stopped.

### SUMMARY

Here, in the case of an internal combustion engine, such as a diesel engine, which burns fuel at an air-fuel ratio larger than a stoichiometric air-fuel ratio at the time of start-up, the fuel is burned at an air-fuel ratio larger than the stoichiometric air-fuel ratio, so that a large amount of oxygen is contained in the exhaust gas discharged from the internal combustion engine. Accordingly, when the internal combustion engine is started up during heating of the filter by heating means that heats the filter to high temperature, a gas discharged from the internal combustion engine supplies oxygen to the filter, which promotes an oxidation reaction of PM in the filter. Accordingly, the filter is overheated by the heat generated by the oxidation reaction, which may deteriorate the filter.

The present disclosure suppresses overheating of a filter provided in an exhaust passage of a vehicle that executes PM regeneration while an internal combustion engine is stopped.

A first aspect of the present disclosure is a vehicle. The vehicle includes a filter disposed in an exhaust passage that carries exhaust gas discharged from an internal combustion engine that burns fuel at an air-fuel ratio larger than a stoichiometric air-fuel ratio at a time of start-up, the filter being configured to collect particulate matter contained in the exhaust gas; a acquiring system that acquire the accumulation amount of particulate matter accumulated on the filter; a heating device that raises temperature of the filter; an air supply device that supplies air to the filter, and an electronic control unit configured to determine that there is a possibility of start-up of the internal combustion engine. The electronic control unit is configured to execute regeneration control that removes the particulate matter accumulated on the filter by supplying air to the filter with the air supply device while raising the temperature of the filter with the heating device, when an accumulation amount of the particulate matter accumulated on the filter is larger than a first accumulation amount while the internal combustion engine is stopped. The electronic control unit is configured to stop the regeneration control when determining that there is the possibility of the start-up of the internal combustion engine during execution of the regeneration control.

With the configuration, the regeneration control is stopped when the possibility of the start-up of the internal combustion engine is detected while the regeneration control is in execution using the heating means and the air supply means during stop of the internal combustion engine. Accordingly, as compared with the case where the regeneration control is continuously executed when the internal combustion engine is started up, increase in temperature of the filter can be suppressed. Accordingly, even when an increased amount of oxygen is supplied to the filter when the filter is at high temperature, the oxidation reaction is suppressed, so that overheating of the filter can be suppressed.

In the vehicle, the electronic control unit may be configured to control the air supply device to promote heat dissipation from the filter when the regeneration control is stopped.

With the configuration, when the possibility of the start-up of the internal combustion engine is detected and the regeneration control is stopped, the filter may be cooled. Consequently, increase in the temperature of the filter can be suppressed at the start-up of the internal combustion engine, so that overheating of the filter caused by the start-up of the internal combustion engine can be suppressed.

In the vehicle, when the regeneration control is stopped, the electronic control unit may be configured to control the air supply device to continue air supply to the filter and may be configured to control the heating device to stop heating of the filter.

With the configuration, when the regeneration control is stopped, heating of the filter by the heating means is stopped, while air supply to the filter by the air supply means is continued. As a result, the amount of heat transfer from the filter to the gas that circulates through the filter increases. Therefore, increase in the temperature of the filter at the start-up of the internal combustion engine can be suppressed, so that overheating of the filter caused by the start-up of the internal combustion engine can be suppressed.

In the vehicle, the electronic control unit may be configured to control the air supply device such that a supply amount of air supplied to the filter by the air supply device after stopping the regeneration control is increased above the supply amount of air supplied to the filter by the air supply device before stopping the regeneration control.

Here, the flow rate of the gas flowing into the filter by the air supply means is a flow rate for supplying the amount of oxygen necessary for removal of the PM, the flow rate being sufficiently smaller than the flow rate of the exhaust gas flowing into the filter by driving of the internal combustion engine. Accordingly, even when the supply amount of air supplied to the filter by the air supply means is increased, the amount of oxygen flowing into the filter becomes sufficiently smaller than the amount of oxygen flowing into the filter by driving of the internal combustion engine. Accordingly, the flow rate of the gas flowing into the filter is increased by increasing the supply amount of air supplied to the filter by the air supply means. Hence, with the configuration, as compared with the case where the supply amount of air supplied to the filter by the air supply means is not increased, the amount of heat transfer from the filter to the gas that circulates through the filter can be increased, so that overheating of the filter can be suppressed.

In the vehicle, the electronic control unit may be configured to control the air supply device such that the supply amount of air supplied to the filter after stopping the regeneration control is decreased below the supply amount of air supplied to the filter during the regeneration control.

When the filter has a large thermal capacity, the filter may be maintained at high temperature for a while even though the regeneration control is stopped and so the heating means is stopped. Accordingly, when the supply amount of air supplied to the filter by the air supply means after the regeneration control is stopped is set equal to the driving amount during execution of the regeneration control, there is a possibility that the oxidation reaction of particulate matter may continue and the filter may be overheated. Accordingly, the amount of oxygen flowing into the filter is decreased by decreasing the supply amount of air supplied to the filter by the air supply means after the regeneration control is stopped. Therefore, with the configuration, the amount of oxygen flowing into the filter is decreased, so that the oxidation reaction of particulate matter in the filter can he suppressed, and thereby overheating of the filter can be suppressed.

In the vehicle, the electronic control unit may be configured to determine that there is the possibility of the start-up of the internal combustion engine when at least one of following conditions is satisfied: i) a seat pressure that is a pressure applied to a seat of the vehicle becomes larger than a specified seat pressure; ii) a door lock of the vehicle is released; iii) there is a response from a smart key that communicates with the vehicle; iv) at least one of an engine hood, a trunk, and an oil filler port of the vehicle opens; and v) a moving object is present in the periphery of the vehicle.

When at least one of the conditions 1) to 5) is satisfied, it is considered that there is a high possibility of the user of the vehicle getting in the vehicle and starting the internal combustion engine mounted on the vehicle. Therefore, with the configuration, when at least one of the conditions 1) to 5) is satisfied, the regeneration control is stopped. As a result, as compared with the case where the regeneration control is continuously executed at the start-up of the internal combustion engine, increase in the temperature of the filter can be suppressed. Accordingly, even when an increased amount of oxygen is supplied to the filter, the oxidation reaction is suppressed, so that overheating of the filter can be suppressed.

The vehicle may include communication device disposed at a location different from the vehicle, the communication device being configured to communicate with a server that calculates a position and a travelling direction of a user of the vehicle based on information on a terminal possessed by the user of the vehicle. The electronic control unit may be configured to determine that there is the possibility of the start-up of the internal combustion engine by receiving from the server a signal indicating that a distance between the vehicle and the user of the vehicle is below a specified distance and the user of the vehicle is advancing in a vehicle direction.

When the distance between the vehicle and the user of the vehicle is below the specified distance and the user of the vehicle is advancing in the vehicle direction, it is considered that there is a high possibility of the user getting in the vehicle and starting the internal combustion engine mounted on the vehicle. Therefore, according to the configuration, when the distance between the vehicle and the user of the vehicle is below the specified distance and the user of the vehicle is advancing in the vehicle direction, the regeneration control is stopped. As a consequence, as compared with the case where the regeneration control is continuously executed at the start-up of the internal combustion engine, increase in the temperature of the filter can be suppressed. Accordingly, even when an increased amount of oxygen is supplied to the filter, the oxidation reaction is suppressed, so that overheating of the filter can be suppressed.

The vehicle may include a cooling mechanism that cools the filter. The electronic control unit may be configured to control the cooling mechanism to promote heat dissipation from the filter when stopping the regeneration control.

According to the configuration, when the possibility of the start-up of the internal combustion engine is detected and the regeneration control is stopped, the cooling mechanism cools the filter. As a consequence, increase in the temperature of the filter at the start-up of the internal combustion engine can be suppressed, so that overheating of the filter caused by the start-up of the internal combustion engine can be suppressed.

In the vehicle, when an upper limit of the supply amount of air supplied by the air supply device is below a specified supply amount, the electronic control unit may be configured to control the air supply device such that the supply amount of air supplied to the filter after stopping the regeneration control is decreased below the supply amount of air supplied to the filter during the regeneration control.

A second aspect of the present disclosure is a control method for a vehicle. The vehicle includes: a filter disposed in an exhaust passage that carries exhaust gas discharged from an internal combustion engine that burns fuel at an air-fuel ratio larger than a stoichiometric air-fuel ratio at the time of start-up, the filter being configured to collect particulate matter contained in the exhaust gas; a heating device that raises temperature of the filter; an air supply device that supplies air to the filter; and an electronic control unit configured to determine that there is a possibility of start-up of the internal combustion engine. The control method includes: executing, the electronic control unit, regeneration control that removes the particulate matter accumulated on the filter by supplying air to the filter with the air supply device while raising the temperature of the filter with the heating device, when the accumulation amount of the particulate matter accumulated on the filter is larger than a first accumulation amount during stop of the internal combustion engine; and stopping, the electronic control unit, the regeneration control when determining that there is the possibility of the start-up of the internal combustion engine during execution of the regeneration control.

With the configuration, the regeneration control is stopped when the possibility of the start-up of the internal combustion engine is detected while the regeneration control is in execution using the heating means and the air supply means during stop of the internal combustion engine. Accordingly, as compared with the case where the regeneration control is continuously executed when the internal combustion engine is started up, increase in the temperature of the filter can be suppressed. As a consequence, even when an increased amount of oxygen is supplied to the filter when the filter is at high temperature, the oxidation reaction is suppressed, so that overheating of the filter can be suppressed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of a vehicle according to a first embodiment of the present disclosure;

FIG. 2 is a flowchart illustrating a routine executed by an ECU illustrated in FIG. 1;

FIG. 3 is a flowchart illustrating a routine executed by the ECU illustrated in FIG. 1;

FIG. 4 is a flowchart illustrating a routine executed by the ECU illustrated in FIG. 1;

FIG. 5 is a flowchart illustrating a routine executed by the ECU illustrated in FIG. 1; and

FIG. 6 is a flowchart illustrating a routine executed by an ECU according to a second embodiment of the present disclosure.

### DETAILED DESCRIPTION OF EMBODIMENTS

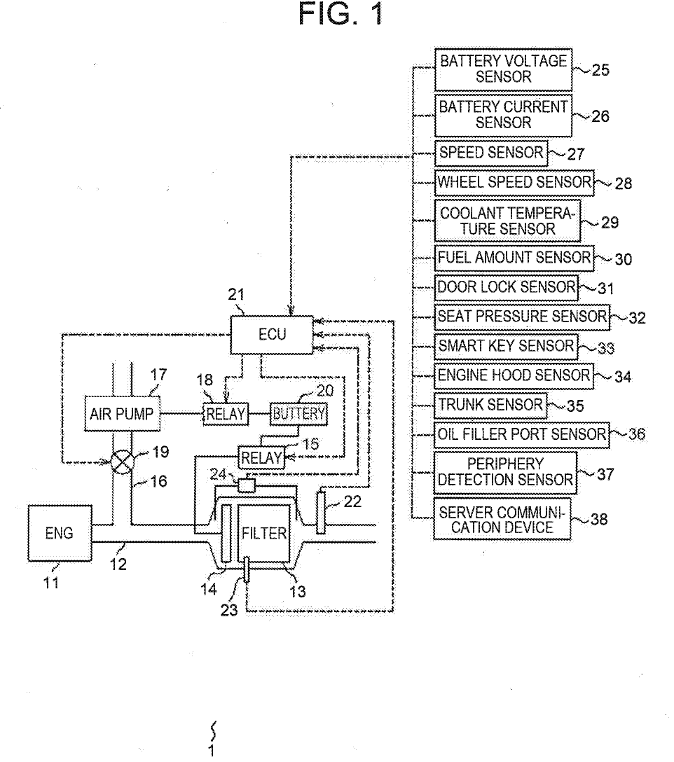

As illustrated in FIG. 1, a vehicle 1 (referred to as “first vehicle” below) according to the first embodiment of the present disclosure includes an internal combustion engine 11. The internal combustion engine 11 is mounted on the vehicle 1 as a driving source. The internal combustion engine 11 is a compression ignition-type internal combustion engine using diesel fuel. The internal combustion engine 11 may be configured to burn fuel at an air-fuel ratio larger than a stoichiometric air-fuel ratio at the time of start-up. The internal combustion engine 11 is connected to an exhaust passage 12 that releases the exhaust gas discharged from the internal combustion engine 11 to the air.

The vehicle 1 includes a filter 13 that collects PM contained in the exhaust gas discharged from the internal combustion engine 11. The filter 13 is provided on the exhaust passage 12. The filter 13 is equipped with a heater 14 at its upstream end portion. The exhaust passage 12 is branched into a secondary air supply pipe 16 on an upstream side of the heater 14. In the middle of the secondary air supply pipe 16, an electro-magnetic valve 19 is disposed. The electro-magnetic valve 19 is configured to prevent backflow of the exhaust gas to a secondary air supply channel during normal operation. The secondary air supply pipe 16 is provided with an air pump 17. When the electro-magnetic valve 19 is put in an opened state and the air pump 17 is driven during stop of the internal combustion engine 11, secondary air is supplied to the exhaust passage 12. Furthermore, when the heater 14 is energized with an electric current supplied from a battery which is not illustrated, the heater 14 generates heat, which removes the PM collected in the filter 13.

The first vehicle further includes an electronic control unit (ECU) 21, an exhaust passage temperature sensor 22, a filter temperature sensor 23, a differential pressure sensor 24, a battery voltage sensor 25, a battery current sensor 26, a speed sensor 27, a wheel speed sensor 28, a coolant temperature sensor 29, a fuel amount sensor 30, a door lock sensor 31, a seat pressure sensor 32, a smart key sensor 33, an engine hood sensor 34, a trunk sensor 35, an oil filler port sensor 36, a periphery detection sensor 37, and a server communication device 38. The ECU 21, which is connected with these sensors, receives signals from the sensors. The ECU 21 is connected with the heater 14 through a semiconductor relay 15. In accordance with a control signal from the ECU 21, energization of the heater 14 is controlled. The ECU 21 is also connected with an air pump 17 through a semiconductor relay 18. In accordance with a control signal from the ECU 21, the driving amount of the air pump 17 is controlled. The ECU 21 sends out an instruction signal to an unillustrated fuel injection valve of the internal combustion engine 11 to change the amount of fuel supplied to a combustion chamber of the internal combustion engine 11. The ECU 21 also sends out an instruction signal to an unillustrated throttle valve to change the amount of intake air to the internal combustion engine 11. The ECU 21 is an electronic control circuit having a microcomputer as a main component part, the microcomputer including a CPU, a ROM, a RAM, and an interface. The CPU implements later-described various functions by executing routines stored in the ROM.

Hereinafter, the sensors and device from which the ECU 21 receives signals will be described. The exhaust passage temperature sensor 22 detects the temperature of the exhaust passage 12 and outputs a signal representative of an exhaust passage temperature Tex. The filter temperature sensor 23 detects the temperature of the filter 13, and outputs a signal representative of a filter temperature Tf. The differential pressure sensor 24 detects a pressure difference between upstream and downstream of the filter 13, and outputs a signal representative of this pressure difference dP. The battery voltage sensor 25 detects a voltage value V of the battery of the vehicle 1 that incorporates the internal combustion engine 11, and outputs a signal representative of the voltage value V of the battery. The battery current sensor 26 detects a current value 1 of the battery of the vehicle 1 that incorporates the internal combustion engine 11, and outputs a signal representative of the current value 1 of the battery. The speed sensor 27 detects a speed NE of a crankshaft which is not illustrated, and outputs a signal representative of the speed NE of the crankshaft. The wheel speed sensor 28 detects a wheel speed of the vehicle 1, and outputs a signal representative of the speed (vehicle speed SPD) of the vehicle 1 based on the wheel speed. The coolant temperature sensor 29 detects temperature (coolant temperature THW) of the coolant that cools the internal combustion engine 11, and outputs a signal representative of the coolant temperature THW. The fuel amount sensor 30 detects a fuel amount FL of the fuel stored in an unillustrated fuel tank of the vehicle 1, and outputs a signal representative of the fuel amount FL. The door lock sensor 31 detects whether or not a door of the vehicle 1 is locked, and outputs a signal representative of whether or not the door of the vehicle 1 is locked. The seat pressure sensor 32 detects the pressure (seat pressure SP) applied to a driver seat of the vehicle 1, and outputs a signal representative of the seat pressure SP. The seat pressure sensor 32 may be disposed not only on the driver seat but also on a passenger seat or a backseat. Accordingly, not only the driver but also passengers of the vehicle 1 can be the user of the first vehicle. The smart key sensor 33 detects whether or not a signal is transmitted from the smart key, and outputs a signal representative of whether or not the signal of the smart key is transmitted. The engine hood sensor 34 detects whether or not the engine hood of the first vehicle is closed, and outputs a signal representative of whether or not the engine hood of the first vehicle is closed. The trunk sensor 35 detects whether or not the trunk of the vehicle 1 is closed, and outputs a signal representative of whether or not the trunk of the vehicle 1 is closed. The oil filler port sensor 36 detects whether or not the oil filler port of the vehicle 1 is closed, and outputs a signal representative of whether or not the oil filler port of the vehicle 1 is closed. The periphery detection sensor 37 detects whether or not the user is present in the periphery of the vehicle 1, and outputs a signal representative of whether or not the user is present in the periphery of the vehicle 1. The periphery detection sensor 37 corresponds to a radar or a camera disposed at the vehicle 1. The server communication device 38 communicates with a server disposed at a location different from the vehicle 1. The server communication device 38 receives from the server a signal representative of whether or not the user is approaching the vehicle 1, and outputs the received signal.

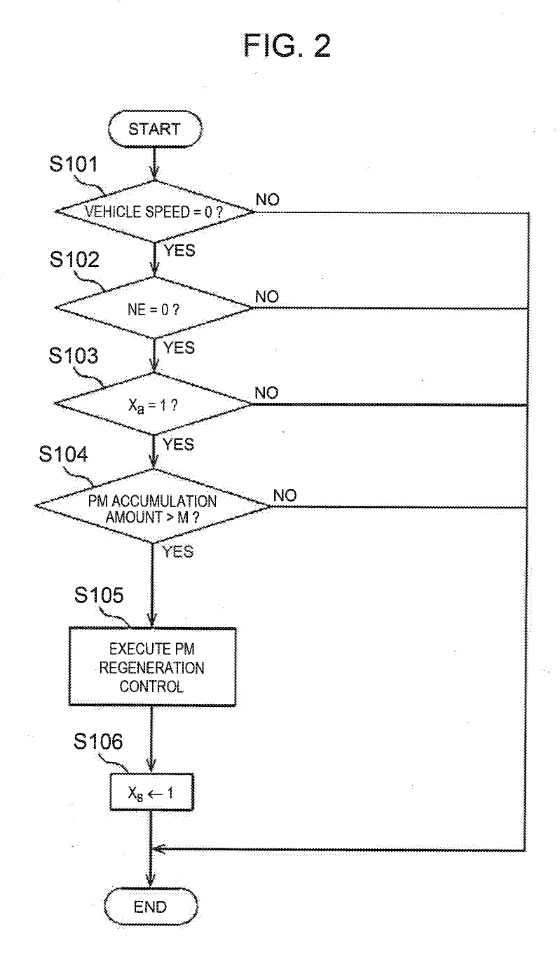

A description is now given of the operation of the CPU. The CPU repeatedly executes processing of a first control routine illustrated in FIG. 2, whenever a prescribed time elapses. Therefore, when a prescribed timing comes, the CPU proceeds to processing of S101 to determine whether or not the vehicle speed SPD is zero, i.e., whether or not the first vehicle incorporating the internal combustion engine 11 is in a stopped state. When the vehicle speed SPD is not zero, i.e., when the first vehicle incorporating the internal combustion engine 11 is moving, the CPU determines “NO” in S101, and temporarily terminates the present routine. When the vehicle speed SPD detected by the wheel speed sensor 28 is zero, i.e., when the first vehicle 1 incorporating the internal combustion engine 11 is in the stopped state, the CPU determines “YES” in S101, and proceeds to processing of S102.

In S102, the CPU determines whether or not the speed NE of the crankshaft of the internal combustion engine 11 is zero, i.e., whether or not the internal combustion engine 11 is in the stopped state. When the speed of the internal combustion engine 11 is not zero, i.e., when the internal combustion engine 11 is not in the stopped state, the CPU determines “NO” in S102, and temporarily terminates the present routine. When the speed of the crankshaft of the internal combustion engine 11 is zero, i.e., when the internal combustion engine 11 is in the stopped state, the CPU determines “YES” in S102, and proceeds to processing of S103.

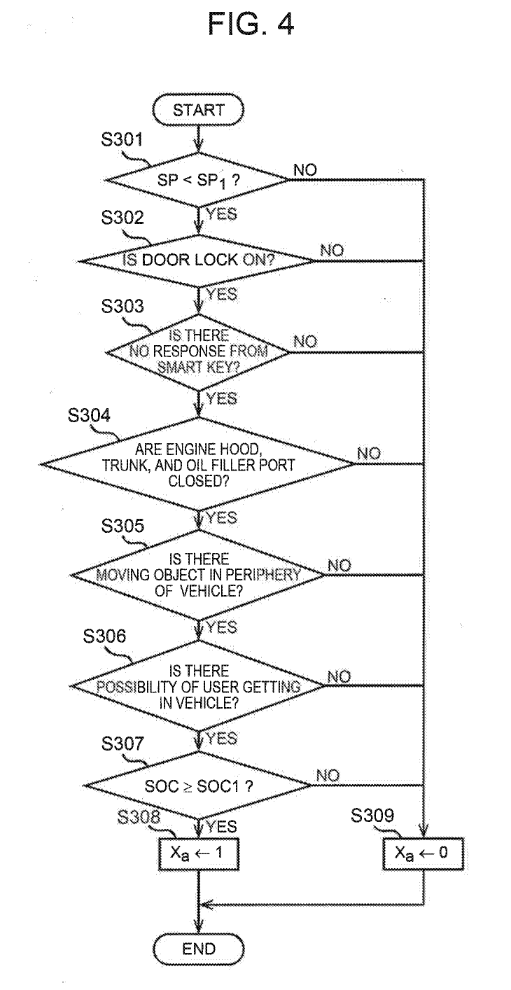

In S103, the CPU determines whether or not a PM regeneration control condition satisfaction flag Xa is “1.” The PM regeneration control condition satisfaction flag Xa is a flag representing whether or not the PM regeneration control is executed during the stop of the internal combustion engine 11. The PM regeneration control condition satisfaction flag Xa will be described later with reference to FIG. 4. When the PM regeneration control condition satisfaction flag Xa is “0”, the CPU determines “NO” in S103, and temporarily terminates the present routine. When the PM regeneration control condition satisfaction flag Xa is “1”, the CPU determines “YES” in S103, and proceeds to processing of S104. The PM regeneration control condition satisfaction flag Xa is set to “0” at the start-up of the ECU 21.

in S104, the CPU determines whether or not the amount of PM accumulated on the filter 13 is larger than a first accumulation amount M. Here, the accumulation amount of PM accumulated on the filter 13 is calculated based on the pressure difference dP between the pressure of the exhaust passage upstream of the filter 13 and the pressure of the exhaust passage downstream of the filter 13 acquired by the differential pressure sensor 24. When the accumulation amount of PM accumulated on the filter 13 is equal to or below the first accumulation amount M, the CPU determines “NO” in S104, and temporarily terminates the present routine. When the amount of PM accumulated on the filter 13 is larger than the first accumulation amount M, the CPU determines “YES” in S104, and proceeds to processing of S105.

In S105, the CPU transmits a signal to the heater 14 and the air pump 17 so as to execute the PM regeneration control. Here, the PM regeneration control is executed such that electric current is supplied from the battery to the heater 14 to heat the heater 14, while electric power is supplied from the battery to the air pump 17 to supply air to the exhaust passage 12. In that case, the amount of electric power to the air pump 17 is controlled such that a supply flow rate P of air supplied by the air pump 17 becomes a first supply flow rate P1. The CPU then proceeds to processing of S106 to set a PM regeneration control execution flag Xs to “1”, and temporarily terminates the present routine. The PM regeneration control execution flag Xs is set to “0” at the start-up of the ECU 21.

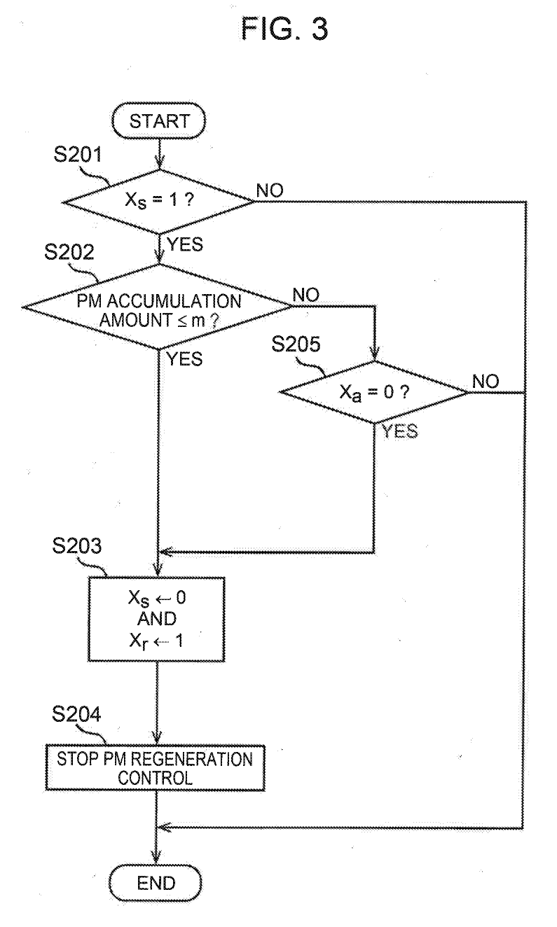

Furthermore, in parallel with the first control routine illustrated in FIG. 2, the CPU repeatedly executes a second control routine illustrated in FIG. 3, whenever a prescribed time elapses. Therefore, when a prescribed timing comes, the CPU proceeds to processing of S201 to determine whether or not the PM regeneration control execution flag Xs is “1.” When the PM regeneration control execution flag Xs is “0”, the CPU determines “NO” in S201, and temporarily terminates the present routine. When the PM regeneration control execution flag Xs is “1”, the CPU determines “YES” in S201, and proceeds to processing of S202.

In S202, the CPU determines whether or not the amount of PM accumulated on the filter 13 is equal to or below a second accumulation amount m. When the amount of PM accumulated on the filter 13 is equal to or below the second accumulation amount m, the CPU determines “YES” in S202, and proceeds to processing of S203.

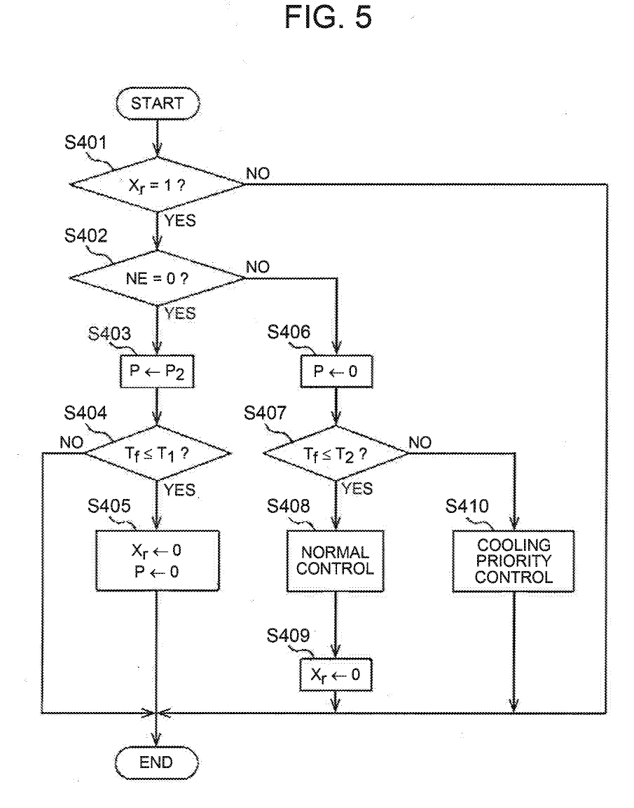

In S203, the CPU sets the PM regeneration control execution flag Xs to “0”, while setting a filter cooling flag Xr to “1”, and proceeds to processing of S204. The filter cooling flag Xr is a flag representing whether or not to execute control of cooling the filter 13. A description thereof will be given later with reference to FIG. 5. In S204, the CPU stops the PM regeneration control and temporarily terminates the present routine. Here, stopping the PM regeneration control refers to stopping supply of electric current from the battery to the heater 14 to stop heating of the heater 14. The PM regeneration control execution flag Xs is set to “0” at the start-up of the ECU 21.

When the amount of PM accumulated on the filter 13 is larger than the second accumulation amount m, the CPU determines “NO” in S202, and proceeds to processing of S205, in S205, the CPU determines whether or not the PM regeneration control condition satisfaction flag Xa is “0.” When the PM regeneration control condition satisfaction flag Xa is “1”, the CPU determines “NO” in S205, and temporarily terminates the present routine. When the PM regeneration control condition satisfaction flag Xa is “0”, the CPU determines “YES” in S205, proceeds to the processing of S203, and executes the above-described operation.

Furthermore, in parallel with the second control routine illustrated in FIG. 3, the CPU repeatedly executes a third control routine illustrated in FIG. 4, whenever a prescribed time elapses. Therefore, when a prescribed timing comes, the CPU proceeds to processing of S301 to determine whether or not the seat pressure SP output from the seat pressure sensor 32 is smaller than a first seat pressure SP1. Here, the first seat pressure SP1 is a value which is smaller than a seat pressure corresponding to the pressure when the user is on the seat and which is larger than a seat pressure corresponding to the pressure when an object other than the user is on the seat. For example, the first seat pressure SP1 is 10 kg. When the seat pressure SP is equal to or above the first seat pressure SP1, i.e., when the user is determined to be on the seat, it can be determined that there is a possibility of the user being in the vehicle and starting up the internal combustion engine 11. Accordingly, the CPU determines “NO” in S301, and proceeds to processing of S309 to set the PM regeneration control condition satisfaction flag Xa to “0”, and temporarily terminates the present routine. When the seat pressure SP is smaller than the first seat pressure SP1, i.e., when it is determined that the user is not on the seat, it can be determined that there is no possibility of the user being in the vehicle and starting up the internal combustion engine 11. Accordingly, the CPU determines “YES” in S301, and proceeds to processing of S302.

In S302, the CPU determines whether or not the door of the vehicle 1 is locked. Whether or not the door of the vehicle 1 is locked is detected by the door lock sensor 31. When the door of the vehicle 1 is not locked, it is assumed that there is a possibility of the user having an intention to get in the vehicle 1 and starting up the internal combustion engine 11. Accordingly, the CPU determines “NO” in S302, proceeds to processing of S309 to set the PM regeneration control condition satisfaction flag Xa to “0”, and temporarily terminates the present routine. When the door of the vehicle 1 is locked, it can be determined that there is a high possibility of the user being away from the vehicle 1. Accordingly, the CPU determines “YES” in S302, and proceeds to processing of S303.

In S303, the CPU determines whether or not there is a response from the smart key. Whether or not there is a response from the smart key is detected by the smart key sensor 33. When there is a response from the smart key, it is assumed that there is a possibility of the user having an intention to get in the vehicle 1 and starting up the internal combustion engine 11. Accordingly, the CPU determines “NO” in S303, proceeds to processing of S309 to set the PM regeneration control condition satisfaction flag Xa to “0”, and temporarily terminates the present routine. When there is no response from the smart key, it can be determined that there is a high possibility of the user being away from the vehicle 1. Accordingly, the CPU determines “YES” in S303, and proceeds to processing of S304.

In S304, the CPU determines whether or not the engine hood which is not illustrated is closed, whether or not the trunk which is not illustrated is closed, and whether or not the oil filler port which is not illustrated is closed. Whether or not the engine hood is closed is detected by the engine hood sensor 34. Whether or not the trunk is closed is detected by the trunk sensor 35. Furthermore, whether or not the oil filler port is closed is detected by the oil filler port sensor 36. When any one of the engine hood, the trunk, and the oil filler port is opened, it is assumed that there is a possibility of the user being in the periphery of the vehicle 1 and starting up the internal combustion engine 11. Accordingly, the CPU determines “NO” in S304, proceeds to processing of S309 to set the PM regeneration control condition satisfaction flag Xa to “0”, and temporarily terminates the present routine. When all of the engine hood, the trunk, and the oil filler port are closed, it can be determined that there is a high possibility of the user being away from the vehicle 1. Accordingly, the CPU determines “YES” in S304, and proceeds to processing of S305.

In S305, the CPU is determined whether or not there is a moving object in the periphery of the first vehicle. Whether or not there is a moving object in the periphery of the first vehicle is detected by the periphery detection sensor 37. When the moving object is present in the periphery of the first vehicle, it is assumed that there is a possibility of the user being in the periphery of the first vehicle and starting up the internal combustion engine 11. Accordingly, the CPU determines “NO” in S305, proceeds to processing of S309 to set the PM regeneration control condition satisfaction flag Xa to “0”, and temporarily terminates the present routine. When there is no moving object in the periphery of the first vehicle, it is considered that there is a high possibility of the user being not in the periphery of the first vehicle. Accordingly the CPU determines “YES” in S305, and proceeds to processing of S306.

In S306, the CPU determines whether or not a signal is received from the server, the signal indicating that there is a possibility of the user getting in the first vehicle. To make the determination, the CPU first acquires a position and a travelling direction of the user from a terminal such as a smartphone possessed by the user, the terminal being configured to transmit a GPS signal. The CPU then transmits a signal including the acquired information to the server disposed separately from the CPU. The CPU also acquires the position of the first vehicle using an unillustrated onboard GPS device incorporated in the first vehicle, and transmits a signal including the acquired information to the server. The server calculates these transmitted signals and transmits to the server communication device 38 of the vehicle 1 a signal including the information regarding whether or not there is a possibility of the user getting in the first vehicle. The case where there is a possibility of the user getting in the vehicle I refers to the case where the distance between the user and the vehicle 1 is below a specified distance and the user is advancing in the direction of the vehicle 1. When it is determined that there is the possibility of the user getting in the vehicle 1, it can be determined that there is a possibility of starting up the internal combustion engine. When it is determined that there is no possibility of the user getting in the vehicle 1, it can be determined that there is no possibility of starting up the internal combustion engine. Accordingly, when it is determined from the signal received by the server communication device 38 that there is no possibility of the user getting in the vehicle 1, the CPU determines “NO” in S306, and proceeds to processing of S309 to set the PM regeneration control condition satisfaction flag Xa to “0”, and temporarily terminates the present routine. When it is determined from the signal received by the server communication device 38 that there is the possibility of the user getting in the vehicle 1, the CPU determines “YES” in S306, and proceeds to processing of S307.

In S307, the CPU determines whether or not a state of charge SOC of the battery is a specified state of charge SOC1 or more. Here, the state of charge SOC of the battery is a value calculated by the CPU based on the voltage value V detected by the battery voltage sensor 25 and the current value I detected by the battery current sensor 26. The state of charge SOC represents a ratio of a present charge amount to a full-charge amount. The specified state of charge SOC1 is a value that can supply electric power necessary for executing the PM regeneration control until the amount of PM accumulated on the filter 13 becomes equal to or below the second accumulation amount m. In the first vehicle, the specified state of charge SOC1 is a value necessary for supplying electric power to the heater 14 and the air pump 17. When the state of charge SOC of the battery is smaller than the specified state of charge SOC1, the CPU determines “NO” in S307, proceeds to processing of S309 to set the PM regeneration control condition satisfaction flag Xa to “0”, and temporarily terminates the present routine. When the state of charge SOC of the battery is equal to or above the specified state of charge SOC1, the CPU determines “YES” in S307, proceeds to processing of S308 to set the PM regeneration control condition satisfaction flag Xa to “1”, and temporarily terminates the present routine.

Furthermore, in parallel with the third control routine illustrated in FIG. 4, the CPU repeatedly executes a fourth control routine illustrated in FIG. 5, whenever a prescribed time elapses. Therefore, when a prescribed timing comes, the CPU proceeds to processing of S401 to determine whether or not the filter cooling flag Xr is “1.” When the filter cooling flag Xr is “0”, the CPU determines “NO” in S401, and temporarily terminates the present routine. When the filter cooling flag Xr is “1”, the CPU determines “YES” in S401, and proceeds to processing of S402.

In S402, the CPU determines whether or not the speed NE of the crankshaft of the internal combustion engine 11 is “0”, i.e., whether or not the internal combustion engine 11 is in the stopped state. The speed NE of the crankshaft of the internal combustion engine 11 is detected by the speed sensor 27. When the speed NE of the crankshaft of the internal combustion engine 11 is “0”, the CPU determines “YES” in S402, and proceeds to processing of S403.

In S403, the CPU controls the amount of electric power to the air pump 17 such that the supply flow rate P of air supplied by the air pump 17 becomes a second supply flow rate P2, and proceeds to processing of S404. Here, the second supply flow rate P2 is a flow rate which is larger than the first supply flow rate P1 set in S105 illustrated in FIG. 2 and which is small enough to prevent the filter 13 from overheating. When the filter 13 is still at high temperature after the PM regeneration control is stopped, and the supply flow rate of air supplied by the air pump 17 is too large, there is a possibility that an oxidation reaction of PM is promoted and thereby the filter 13 is overheated. Accordingly, the second supply flow rate P2 is a supply flow rate of air small enough to prevent the filter 13 from overheating. When the supply flow rate of air supplied by the air pump 17 after stopping the PM regeneration control is increased above the supply amount of air supplied before stopping the PM regeneration control, a larger amount of heat can be released from the filter 13. Accordingly, the temperature of the filter 13 can be lowered at a higher rate.

In S404, the CPU determines whether or not the temperature Tf of the filter 13 is equal to or below a first temperature T1. When the temperature Tf of the filter 13 is larger than the first temperature T1, the CPU determines “NO” in S404, and temporarily terminates the present routine. When the temperature Tf of the filter 13 is equal to or below the first temperature T1, the CPU determines “YES” in S404, and proceeds to processing of S405.

In S405, the CPU sets the filter cooling flag Xr to “0”, while setting the electric power supply to the air pump 17 to “0” so as to set the supply flow rate P of air supplied by the air pump 17 to “0.” The CPU then temporarily terminates the present routine.

In S402, when the speed NE of the crankshaft of the internal combustion engine 11 is not “0”, i.e., when the internal combustion engine 11 is rotating, the CPU determines “NO”, and proceeds to processing of S406. In S406, the CPU sets the electric power supply to the air pump 17 to “0” so as to set the supply flow rate P of air supplied by the air pump 17 to “0”, and proceeds to processing of S407.

In S407, the CPU determines whether or not the temperature Tf of the filter 13 is equal to or below a second temperature T2. Here, the second temperature T2 is set to a value larger than the first temperature TI. When the temperature Tf of the filter 13 is equal to or below the second temperature T2, the CPU determines “YES” in S407, and proceeds to processing of S408.

In S408, the CPU sets the speed NE of the crankshaft of the internal combustion engine 11 so as to satisfy an output request by the user (normal control), and proceeds to processing of S409. In S409, the CPU sets the filter cooling flag Xr to “0”, and temporarily terminates the present routine.

In S407, when the temperature Tf of the filter 13 is equal to or below the second temperature T2, the CPU determines “NO” in S407, and proceeds to processing of S410. In S410, the speed NE of the crankshaft of the internal combustion engine 11 is larger than the speed during normal idling. The speed NE is also a value calculated based on the amount of PM accumulated on the filter 13 and the temperature Tf of the filter 13, the value being small enough to prevent the filter 13 from overheating. Even when the internal combustion engine 11 is started up, a gas circulates through the filter 13, so that the amount of heat transfer from the filter 13 to the gas circulating through the filter 13 can be increased. The speed immediately after start-up of the internal combustion engine 11 is normally equal to the speed during idling. Since the flow rate of the exhaust gas discharged from the internal combustion engine is limited, the temperature of the filter 13 may not sufficiently he lowered to the second temperature T2 or below. Accordingly, when an acceleration request is made while the temperature of the filter 13 is larger than the second temperature, the speed of the internal combustion engine 11 increases. As a result, the amount of oxygen supplied to the filter 13 may also be increased, which may cause overheating of the filter 13. To cope with such a situation, the speed of the crankshaft of the internal combustion engine 11 is set to a speed which is larger than the speed during normal idling and which is low enough to prevent the filter 13 from overheating. Accordingly, the flow rate of the gas circulating through the filter 13 is increased, and thereby the amount of heat transfer from the filter 13 to the gas circulating through the filter 13 is increased. As a consequence, overheating of the filter 13 is suppressed.

As described in the foregoing, according to the first vehicle, PM regeneration control processing is stopped when arty one of the conditions S301 to S306 stated in FIG. 4 is not satisfied, i.e., when there is a possibility of the start-up of the internal combustion engine 11, while the internal combustion engine 11 is in the stopped state and the amount of PM accumulated on the filter 13 is larger than the first accumulation amount. Accordingly, increase in the temperature of the filter 13 can be suppressed as compared with the case where the PM regeneration control processing is continuously executed when the internal combustion engine 11 is started up. Therefore, even when the amount of oxygen supplied to the filter 13 is increased due to the start-up the internal combustion engine 11, the oxidation reaction of PM in the filter 13 is suppressed, so that the overheating of the filter 13 can be suppressed.

According to the first vehicle, when the PM regeneration control processing is stopped, heating with the heater 14 is stopped while driving of the air pump 17 is continued, so that the amount of heat transfer from the filter 13 to the gas circulating through the filter 13 increases. Therefore, it becomes possible to lower the temperature of the filter 13 at the start-up of the internal combustion engine 11, so that overheating of the filter 13 caused by the start-up of the internal combustion engine 11 can be suppressed.

Furthermore, when the driving amount of the air pump 17 is increased, the flow rate of the gas flowing into the filter 13 is increased. Accordingly, as compared with the case where the driving amount of the air pump 17 is not increased, the amount of heat transfer from the filter 13 to the gas flowing into the filter 13 can be increased, which makes it possible to suppress increase in the temperature of the filter.

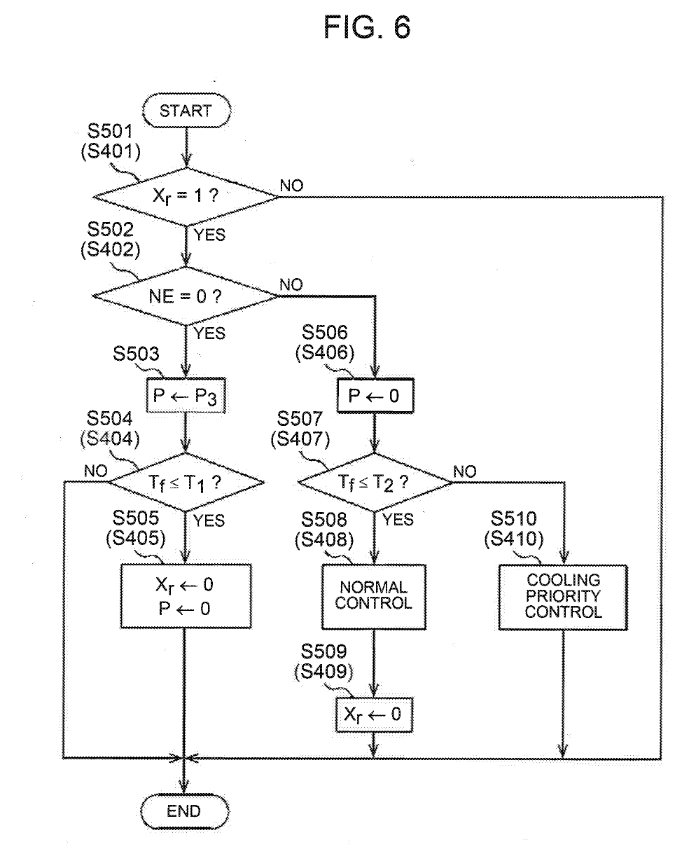

A description is now given of a vehicle (referred to as “second vehicle” below) according to the second embodiment of the present disclosure. The second vehicle is different from the first vehicle only in the point that the ECU 21 executes a routine illustrated in FIG. 6 in place of the routine illustrated in FIG. 5. Specifically, the first vehicle is different from the second vehicle in the point that the first vehicle increases the supply flow rate of air by the air pump 17 after the PM regeneration control is stopped and when the speed of the internal combustion engine 11 is “0”, whereas the second vehicle decreases the supply flow rate of air by the air pump 17 after the PM regeneration control is stopped and when the speed of the internal combustion engine 11 is “0.”The point of difference will mainly be described below.

In the second vehicle, steps S501 through S510 in the routine illustrated in FIG. 6 are the steps, except for S503, that perform the processing same as S401 through S410 in the routine illustrated in FIG. 5. Among the steps illustrated in FIG. 6, the steps that perform the processing identical to those of the steps illustrated in FIG. 5 are affixed with reference signs in parentheses, the reference sings being illustrated in FIG. 5. Accordingly, for example, S501 (S401) in FIG. 6 indicates that S501 is the step that performs the processing same as that in S401. Hereinafter, a description is mainly given of the processing of “S503” that is peculiar to the routine illustrated in FIG. 6.

In S503, the vehicle I controls the amount of electric power to the air pump 17 such that the supply flow rate P of air supplied by the air pump 17 becomes a third supply flow rate P3. The CPU then proceeds to processing of S504. Here, the third supply flow rate P3 is a flow rate smaller than the first supply flow rate P1 set in S105. The third supply flow rate P3 includes a supply flow rate of air defined as zero. When the filter 13 has a large thermal capacity, the filter 13 may be maintained at high temperature for a while even though the PM regeneration control is stopped and so the heating means is stopped. Accordingly, when the supply flow rate of air supplied by the air pump 17 after the stop of the PM regeneration control is equal to the supply flow rate during execution of the PM regeneration control, there is a possibility that the oxidation reaction of PM may continue and the filter 13 may be overheated. Accordingly, in S503, the second vehicle sets the supply flow rate P of air supplied by the air pump 17 to a flow rate P3 which is smaller than the first supply flow rate P1.

As described in the foregoing, according to the second vehicle, the driving amount of the air pump after the stop of the PM regeneration control is decreased. When the driving amount of the air pump after the stop of the PM regeneration control is decreased, the amount of oxygen flowing into the filter decreases. Accordingly, the oxidation reaction of PM in the filter can be suppressed, and overheating of the filter can be suppressed. When the air pump 17 is continuously driven, while the driving amount of the air pump after the stop of the PM regeneration control is decreased, not only the effect of stopping the driving of the air pump after the stop of the PM regeneration control is exhibited, but also a flow of the gas passing through the filter is generated. As a result, the amount of heat transfer from the filter to the gas circulating through the filter can be increased, so that overheating of the filter 13 can be suppressed. When an upper limit of the supply flow rate of air, which can be supplied by the air pump 17, is smaller than the second supply flow rate P2 due to the performance of the air pump 17, it is difficult to lower the temperature of the filter 13 by increasing the supply flow rate of air supplied by the air pump 17 after the stop of the PM regeneration control to be larger than the supply amount of air before the stop of the PM regeneration control as in the case of the first vehicle. Accordingly, when the upper limit of the supply flow rate of air that can be supplied by the air pump 17 is smaller than the second supply flow rate P2, the supply flow rate P of air supplied by the air pump 17 is set to the third supply flow rate P3, so that the overheating of the filter can be suppressed.

In the first vehicle and the second vehicle, the temperature of the filter 13 is raised by heating the filter 13 with the heater 14 as heating means. However, the heating means is not limited to the heater 14 as long as the temperature of the filter 13 is raised. For example, in place of the heater 14, a fuel addition valve and a fuel ignition device may be provided in a portion of the exhaust passage upstream of the filter 13. A fuel may be added from the fuel addition valve, and be ignited by the fuel ignition device to raise the temperature of exhaust gas supplied to the filter 13 and to thereby raise the temperature of the filter 13. Here, the fuel ignition device refers to a glow plug or an ignition device. The heater 14 may he replaced with a microwave generator, which irradiates the filter 13 with a microwave to raise the temperature of the filter 13. Furthermore, an electric heating-type filter may he used as the filter 13, and the temperature of the filter 13 may be raised by applying electric current to the filter 13.

In the first vehicle and the second vehicle, when the temperature of the filter 13 is larger than the first temperature TI after the stop of the PM regeneration control, the flow rate of the air pump is changed to suppress increase in the temperature of the filter 13. However, other means may be used to suppress the increase in the temperature of the filter 13. For example, separately from the secondary air supply pipe 16, a supply channel that supplies a gas may be provided. The gas supplied from the supply channel is fed into the filter 13 to increase the amount of heat transfer from the filter 13 to the gases passing through the filter 13 for suppressing the increase in the temperature of the filter 13. Furthermore, a coolant channel may be provided to circulate a coolant around the filter 13. When the temperature of the filter 13 is larger than the first temperature T1 after the PM regeneration control is stopped, the coolant may be circulated through the coolant channel to suppress the increase in the temperature of the filter 13. Furthermore, supply means may be provided to supply a liquid to the filter 13. When the temperature of the filter 13 is above the first temperature T1 after the PM regeneration control is stopped, the liquid may be injected to the filter 13 such that the liquid is evaporated to generate heat of evaporation, which may suppress the increase in the temperature of the filter 13.

Furthermore, in the first vehicle and the second vehicle, the accumulation amount of PM accumulated on the filter 13 is acquired using the differential pressure sensor 24. However, the method for acquiring the accumulation amount of PM accumulated on the filter 13 is not limited thereto. For example, the accumulation amount of PM accumulated on the filter 13 may be acquired based on driving time of the internal combustion engine 11 after the last execution of the PM regeneration control or based on a specified distance of the vehicle I after the last execution of the PM regeneration control. Furthermore, the accumulation amount of PM accumulated on the filter 13 may be acquired by calculating the amount of PM discharged from the internal combustion engine 11 based on the load of the internal combustion engine 11.

Furthermore, in the first vehicle and the second vehicle, the air pump 17 is used as air supply means. However, other means may be used for supplying air to the filter 13. For example, the air supply means may be an electric supercharger provided in an intake passage which is not illustrated. The intake passage is branched into a bypass channel on the downstream side of the electric supercharger, the bypass channel being connected to the exhaust passage 12 on the upstream side of the heater 14. When the PM regeneration control is executed, the electric supercharger is driven to generate an air flow in the intake passage. The air flow generated in the intake passage may partially be circulated to the bypass channel by opening a valve provided in the bypass channel, so that air is supplied to the filter 13.

What is claimed is:

1. A vehicle comprising:
a filter disposed in an exhaust passage that carries exhaust gas discharged from an internal combustion engine that burns fuel at an air-fuel ratio larger than a stoichiometric air-fuel ratio at a time of start-up, the filter being configured to collect particulate matter contained in the exhaust gas;
a acquiring system that acquire the accumulation amount of particulate matter accumulated on the filter;
a heating device that raises temperature of the filter;
an air supply device that supplies air to the filter; and
an electronic control unit, the electronic control unit being configured to execute regeneration control that removes the particulate matter accumulated on the filter by supplying air to the filter with the air supply device while raising the temperature of the filter with the heating device, when the accumulation amount of the particulate matter accumulated on the filter is larger than a first accumulation amount during stop of the internal combustion engine, the electronic control unit being configured to determine that there is a possibility of start-up of the internal combustion engine, the electronic control unit being configured to stop the regeneration control when determining that there is the possibility of the start-up of the internal combustion engine during execution of the regeneration control.

2. The vehicle according to claim 1, wherein
the electronic control unit is configured to control the air supply device to promote heat dissipation from the filter when the regeneration control is stopped.

3. The vehicle according to claim 2, wherein
when the regeneration control is stopped, the electronic control unit is configured to control the air supply device to continue air supply to the filter and is configured to control the heating device to stop heating of the filter.

4. The vehicle according to claim 3, wherein
the electronic control unit is configured to control the air supply device such that a supply amount of air supplied to the filter by the air supply device after stopping the regeneration control is increased above the supply amount of air supplied to the filter by the air supply device before stopping the regeneration control.

5. The vehicle according to claim 3, wherein
the electronic control unit is configured to control the air supply device such that a supply amount of air supplied to the filter after stopping the regeneration control is decreased below the supply amount of air supplied to the filter during the regeneration control.

6. The vehicle according to claims 1, wherein
the electronic control unit is configured to determine that there is the possibility of the start-up of the internal combustion engine when at least one of following conditions is satisfied:
i) a seat pressure that is a pressure applied to a seat of the vehicle becomes larger than a specified seat pressure;
ii) a door lock of the vehicle is released;
iii) there is a response from a smart key that communicates with the vehicle;
iv) at least one of an engine hood, a trunk, and an oil filler port of the vehicle opens; and
v) a moving object is present in a periphery of the vehicle.

7. The vehicle according to claim 1, further comprising
communication device disposed at a location different from the vehicle, the communication device being configured to communicate with a server that calculates a position and a travelling direction of a user of the vehicle based on information on a terminal possessed by the user of the vehicle,
wherein the electronic control unit is configured to determine that there is the possibility of the start-up of the internal combustion engine by receiving from the server a signal indicating that a distance between the vehicle and the user of the vehicle is below a specified distance and the user of the vehicle is advancing in the vehicle direction.

8. The vehicle according to claim 1, further comprising
a cooling mechanism that cools the filter,
wherein the electronic control unit is configured to control the cooling mechanism to promote heat dissipation from the filter when stopping the regeneration control.

9. The vehicle according to claim 5, wherein
the electronic control unit is configured to control the air supply device such that the supply amount of air supplied to the filter after stopping the regeneration control is decreased below the supply amount of air supplied to the filter during the regeneration control, when an upper limit of the supply amount of air supplied by the air supply device is below a specified supply amount.

10. A control method for a vehicle,
the vehicle including: a filter disposed in an exhaust passage that carries exhaust gas discharged from an internal combustion engine that burns fuel at an air-fuel ratio larger than a stoichiometric air-fuel ratio at a time of start-up, the filter being configured to collect particulate matter contained in the exhaust gas; a acquiring system that acquire the accumulation amount of particulate matter accumulated on the filter; a heating device that raises temperature of the filter; an air supply device that supplies air to the filter; and an electronic control unit configured to determine that there is a possibility of start-up of the internal combustion engine,
the control method comprising:
executing, the electronic control unit, regeneration control that removes the particulate matter accumulated on the filter by supplying air to the filter with the air supply device while raising the temperature of the filter with the heating device, when the accumulation amount of the particulate matter accumulated on the filter is larger than a first accumulation amount while the internal combustion engine is stopped; and
stopping, the electronic control unit, the regeneration control when determining that there is the possibility of the start-up of the internal combustion engine during execution of the regeneration control.
